(19) United States
(12) Patent Application Publication
(10) Pub. No.: US 2004/0133681 A1
(43) Pub. Date: Jul. 8, 2004

(54) Method for creating or changing subscriber-related entries in a database

(75) Inventor: Christian Wietfeld, Falkensee (DE)

Correspondence Address: MORRISON & FOERSTER LLP, 1650 TYSONS BOULEVARD, SUITE 300, MCLEAN, VA, 22102, US

(73) Assignee: Siemens AG, Munich (DE)

(21) Appl. No.: 10/679,511

(22) Filed: Oct. 7, 2003

(30) Foreign Application Priority Data
Oct. 7, 2002 (DE) 10246692.0

(51) Int. Cl. G06F 15/173; H04M 3/42

(52) U.S. Cl. 709/226; 379/201.12; 455/414.1

(57) ABSTRACT

Method for creating or changing subscriber-related entries in a first database of a service which is implemented using HTTP. According to the method, a previously implemented trigger is activated on the basis of an HTTP proxy platform when the service is called. User-entered service-related and subscriber-related data is called from a second database and is created or modified in the first database and after installation is complete. The trigger in the platform is deactivated on a subscriber-related basis.

### CLAIM FOR PRIORITY

This application claims priority to German Application No. 10246692.0 filed Oct. 7, 2002, which is incorporated herein, in its entirety, by reference.

### TECHNICAL FIELD OF THE INVENTION

The invention relates to a method for creating or changing subscriber-related entries in a database and more specifically to an arrangement for executing this method.

### BACKGROUND OF THE INVENTION

There has, over many years, been a highly dynamic development of telecommunications networks into information and entertainment media that are fast, efficient and accessible to a wide range of users. As part of this development, a wide variety of data services were created to supply registered users continuously with data (information or entertainment) in accordance with a pre-specified profile. In the meantime, it has become possible to personalize many of these data services, including, in particular, data services which use the HTTP protocol for data transmission. The execution of the service is thus dependent on information or settings which are assigned to an individual user or a user group. This can involve the subscriber names, the home address (for a location-independent service), a personal services portfolio (portal) or also a Calling Line Identification (CLID).

The provision of a personalized service requires what is known as the “creation” of the user (subscriber) in a database of the corresponding service platform, i.e. the entry of user-related data into this database.

This is done initially by what is known as “manual provisioning”, through a call by the user to a customer care operative of the service and notification in person of the corresponding data to the latter. The customer care operative then accesses the database and makes the necessary entries immediately as a result of information supplied by the customer. This type of creation of a subscriber and (linked to this) activation of a personal service thus demands a considerable outlay in human resources, at least for services with wide usage, and is linked to the corresponding personnel costs. A disadvantage for the acceptance of such a service is that the subscriber must overcome a certain entry barrier to make the required call to the customer care operator and “disclose” this personal data.

With what is known as “bulk provisioning” all subscribers of a telecoms network are set up provisionally as potential users of a service to be established. In this case, each entry must be made sequentially and there must be ongoing synchronization of the database. Specifically, for large networks with many subscribers, this requires the provision or use of significant processing resources and also a relatively large amount of time. This can, depending on the scope of the data to be created, take between several hours and a few days.

Furthermore it is also possible and in practice normal for the users to create their data record in the database themselves via a user-controlled dialog, which is known as self-provisioning. This procedure is relatively inexpensive for the service providers who generally only have to implement the access facilities and the user dialog. However the problem is the exceptionally high entry barrier: Only experienced users of data services have the confidence to personalize a data service themselves. This can cost the provider significant market share, especially in a mass market.

For mobile data services based on WAP (Wireless Application Protocol) what is known as “WAP auto provisioning” has become known. An appropriate function is used here to check whether a subscriber is created in the WAP gateway of the corresponding mobile radio network. The basic mechanism provides the option of expansion to further service platforms. It is however not possible, regardless of the status of the WAP gateway, to initiate further provisioning processes. In a market in which users already active in specific services should be able to be easily created on other service platforms, this deficit represents a very major disadvantage.

### SUMMARY OF THE INVENTION

According to an aspect of the invention, an improved method and an arrangement for performing the method, which especially on one side requires only a relatively modest expenditure by the service provider and on the other side presents no problems to potential users and therefore raises no entry barriers, are provided.

According to another aspect of the invention, an HTTP proxy may be used, depending on a service-specific trigger, to initiate the creation or personalization process. Initiation is undertaken when the corresponding service is called via the activation of the trigger previously mentioned. As soon as the process has been successfully completed, the trigger (provisioning trigger) within the HTTP proxy platform is deactivated again on a subscriber-related basis.

The HTTP traffic can in this case for example be analyzed in relation to calling a specific URL. As soon as the corresponding (prespecified) URL is called and the assigned trigger is activated, a specified creation process sequence takes over calling the entries relating to the current service from an external database (as regards the service under discussion) and the required data is installed into the service-specific platform (database).

The proposed method is basically suitable for all service platforms accessed via the HTTP traffic path and can be practically employed at any sensible time. In particular, in addition to the first activation of a service for a new subscriber—to a certain extent with an initial trigger—triggers can also be set an any later point to modify entries that are already present or also to create or activate subscribers on further platforms.

According to a further aspect of the invention, unlike the “bulk provisioning” mentioned above, only subscribers in the service database who will actually use the service are created in the service database. This allows the service database to be dimensioned appropriately for the use made of it.

According to a preferred aspect of the invention, data originating from a subscriber dialog is included in the creation and modification of the service-related or subscriber-related data. This makes it possible to incorporate additional information supplied directly by the user into the creation process. In the result the dataset of the service database can be expanded compared to that of the external database (central customer database or such like).

The functionality provided by the proposed solution can also be used to migrate users from one service platform to another, and to do this at the point at which a subscriber starts to use the “new” service for the first time. With this variant, the two databases involved are local databases of the corresponding services.

### BRIEF DESCRIPTION OF THE DRAWINGS

The invention is explained with reference to the drawings, in which:

FIG. 1 is a synoptic representation which shows both major function components of a preferred embodiment of the proposed systems and also the main steps involved in the method.

### DETAILED DESCRIPTION OF THE INVENTION

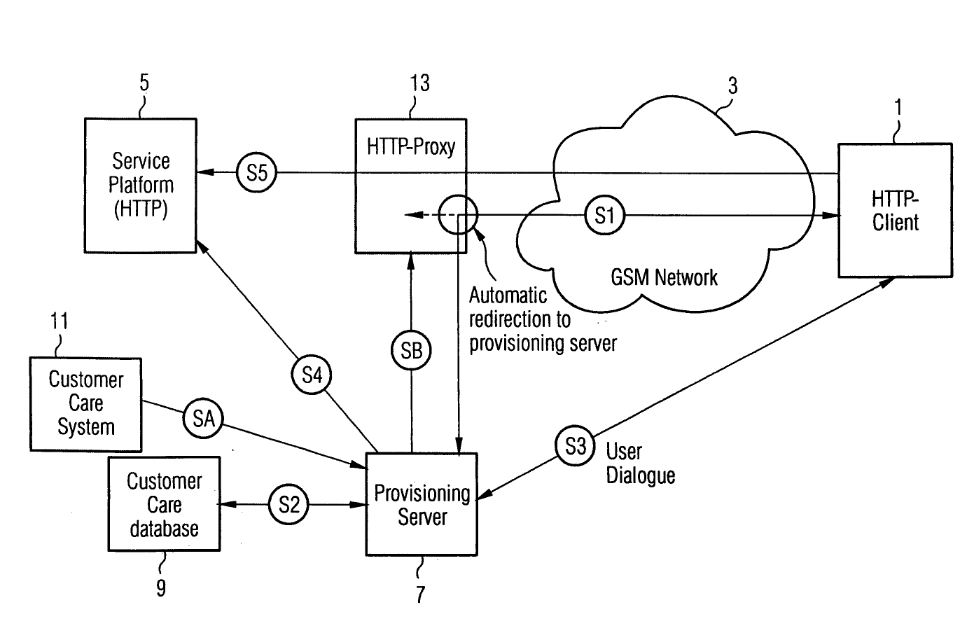

With the configuration shown in FIG. 1, a user terminal (HTTP client) 1 of a potential service user can be connected via a GSM network 3 to an HTTP service platform 5 on one side and to a provisioning server 7 on the other side. The provisioning server 7 is in its turn linked to a central customer care database 9 and a customer care system 11 of the mobile radio network. In the connection between the user terminal 1 and HTTP service platform 5 an HTTP-Proxy 13 is “connected in” as an aid to installation of the customer data on the platform.

When the new service is established, the provisioning server 7 is sent information by the customer care system 11 in a configuration process SA regarding the progress of data creation on the service platform (data to be provided, type of trigger etc.). In a subsequent process SB, the provisioning server 7 sets in HTTP proxy 13 the trigger to redirect an (initial) request, which is directed from the user terminal 1 to service platform 5.

As a result of this trigger, the HTTP request is redirected to the provisioning server 7 in a Step: S1. In a subsequent Step: S2, synchronization with the customer care database 9 is undertaken in which, optionally, data from a user dialog conducted in parallel between the provisioning server 7 and the user terminal 1 (Step: S3) is incorporated. In the result, in Step: S4, either a new user account is created or an existing entry is updated. Finally, in Step: S5, the session requested by the user with their HTTP request is restarted and the user terminal is connected to the service platform 5. The service can now be used on the basis of current user data.

This aspect of the invention is not restricted to this example but is also possible in modified forms that lie within the area of specialist activity.

What is claimed is:

1. A method for creating or changing subscriber-related entries in a first database of a service that is implemented via HTTP, comprising:
activating a previously implemented trigger on the basis of an HTTP proxy platform when the service is called;
calling user-entered service-related and subscriber-related data from a second database, the user-entered service-related and subscriber-related data being created or changed in the first database; and
deactivating the trigger in the platform after installation is complete on a subscriber-related basis.

2. The method according to claim 1, wherein the first database is a local database and the second database is a central customer database, in which subscriber-related data of a number of services is stored.

3. The method according to claim 1, wherein the first and second database are local databases of a first and second service, whereby the subscriber is migrated from the second to the first service.

4. The method according to claim 1, wherein accessing a URL assigned to a particular service is evaluated as a call to the service.

5. The method according to claim 1, wherein data originating from a subscriber dialog is incorporated into the creation or modification of the service-related and subscriber-related data.

6. The method according to claim 1, wherein the service involved is a service provided by a GSM network.

7. A system for creating or changing subscriber-related entries in a first database of a service that is implemented via HTTP, comprising:
a first database which is assigned to an HTTP service platform;
a second database;
a provisioning server working in conjunction with the first and second database for installation of service and subscriber-related entries into the first database on the basis of data originating from the second database; and
an HTTP proxy connected upstream from an HTTP Client of the HTTP service platform and working in conjunction with the provisioning server to install or modify the entries in the first database.
